(19) United States
(12) Patent Application Publication
(10) Pub. No.: US 2011/0115911 A1
(43) Pub. Date: May 19, 2011

(54) ON-BOARD REAR VIEW MIRROR WITH AN ELECTRONIC VIDEO-AUDIO RECORDER

(76) Inventor: Kuo-Tsai FANG, Yonghe City (TW)

(21) Appl. No.: 12/621,858

(22) Filed: Nov. 19, 2009

(51) Int. Cl. H04N 7/18

(52) U.S. Cl. 348/148; 348/E07.085

(57) ABSTRACT

An on-board rear view mirror with an electronic video-audio recorder includes a mirror case which contains an electronic video-audio recorder. The electronic video-audio recorder includes a recorder mainboard and a processor, a camera ball, a data storage card, a microphone, a vehicle speed signal wire and a time processing unit displaying time and date in real time, that are connected with the recorder mainboard. The camera ball contains plural camera heads in plural directions. By the aforementioned structures, not only that images and sound inside and outside a vehicle can be effectively recorded, but that a vehicle speed can be recorded in real time.

### BACKGROUND OF THE INVENTION

a) Field of the Invention

The present invention relates to an on-board rear view mirror, and more particularly to an on-board rear view mirror with an electronic video-audio recorder, which can record images and sound inside and outside a vehicle and can record a speed of the vehicle in real time.

b) Description of the Prior Art

There are very few direct image records to be searched for when vehicles are moving on roads. Therefore, after many traffic incidents have occurred, it is very difficult to determine really fairly who is right and who is wrong, who should take responsibility of the incident, what is the real cause of the incident and whether there is a means to prevent from causing the incident again. The truths can be recovered by video-audio records at the time of incident. There is now a product called “video-recording rear view mirror for vehicles” wherein a piece of the rear view mirror having a photographing function is hung on an original on-board rear view mirror and then a power cord is plugged into a cigar lighter in the vehicle, thereby achieving an object of recording images in front when the vehicle is moving. However, as belonging to a post-assembled accessory, this product becomes very easily a target of a thief who will break a window of the vehicle to steal. As a result, an owner of the vehicle has to dismantle the equipment when he or she gets off the vehicle and then re-install it after getting on the vehicle. In addition, as the installation is complicated, a camera angle needs to be adjusted and fixed, and then a power source needs to be connected, the vehicle owner will usually miss out shooting when taking a short drive, being in a hurry or forgetting to install. At a same time, as being covered on the original on-board rear view mirror, the product is wider than the on-board rear view mirror which is planned by an original vendor according to a safety design, and is closer to a head of driver. Furthermore, the product is fixed by using movable clamps. These approaches will form some severe hidden troubles, including that a line of sight of the driver will be affected and the added rear view mirror can become a projectile in the vehicle to severely damage on-board passengers when collision happens, which has already occurred in past accidents. Accordingly, all well-known automobile manufacturers now will have strict standards and regulations regarding the way of fixing the on-board rear view mirror, to prevent from causing a secondary injury by the on-board rear view mirror when the collision happens. Some main stream automobile safety research institutes will also advise consumers not to add on the original rear view mirror an enlarged rear view mirror and suspended decorations. Greater regrets of the aforementioned product are that there is only one camera lens to shoot images in front and a vehicle speed signal is not connected. Hence, if pictures at peripheries of the vehicle need to be shot, then plural camera lenses should be installed additionally at the peripheries of the vehicle. This will damage an original wiring of the vehicle, decorations in the vehicle or even integrity of an auto body. As the aforementioned product is also a post-assembled accessory and belongs to a vehicle accessory which is directly purchased and installed by the vehicle owner, the product design is too dispersed to be integrated as a full standard fitting and thus is unable to be provided to the automobile manufacturer which uses the product as standard equipment to be fitted directly on a new vehicle. Therefore, the product cannot be popularized and more drivers will not be able to use and accept it more conveniently, reliably and safely.

### SUMMARY OF THE INVENTION

The primary object of the present invention is to provide an on-board rear view mirror with an electronic video-audio recorder, which includes a mirror case containing an electronic video-audio recorder. The electronic video-audio recorder is composed of a recorder mainboard, and a processor, a camera ball, a data storage card, a microphone, a time processing unit and a vehicle speed signal which are connected with the recorder mainboard through connection wires. The camera ball includes plural camera heads in plural directions, and the electronic video-audio recorder is assembled in an on-board rear view mirror; whereas three lead wires are connected respectively with an on-board power cord, a vehicle speed signal wire and a USB (Universal Serial Bus) port. Except for the camera ball, all parts, connection wires and lead wires of the electronic video-audio recorder are hidden in the mirror case of the rear view mirror.

A second object of the present invention is to provide an on-board rear view mirror with an electronic video-audio recorder, wherein as being assembled in an on-board rear view mirror, the electronic video-audio recorder is covered well without being stolen and affecting a line of sight of a driver.

A third object of the present invention is to provide an on-board rear view mirror with an electronic video-audio recorder, wherein images are automatically shot when a power source is automatically connected after a vehicle has started, so that the electronic video-audio recorder will not be installed repeatedly and a user will not miss out shooting by forgetting to activate the electronic video-audio recorder.

A fourth object of the present invention is to provide an on-board rear view mirror with an electronic video-audio recorder, which can operate reliably to extend a lifetime of usage, as the electronic video-audio recorder is directly exposed to sunlight.

A fifth object of the present invention is to provide an on-board rear view mirror with an electronic video-audio recorder, wherein as the electronic video-audio recorder is assembled in an on-board rear view mirror, camera heads will not swing and the electronic video-audio recorder will not become a projectile to cause an accidental injury when two vehicles collide.

A sixth object of the present invention is to provide an on-board rear view mirror with an electronic video-audio recorder, wherein pictures in plural angles can be shot, an entire property is good and the electronic video-audio recorder can be easily installed.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of an electronic video-audio recorder of a preferred embodiment of the present invention.

FIG. 2 shows a front view of the preferred embodiment of the present invention.

FIG. 3 shows a rear view of the preferred embodiment of the present invention.

FIG. 4 shows a schematic view of a state of use of the preferred embodiment of the present invention.

### DETAILED DESCRIPTION OF THE PREFERRED EMBODIMENTS

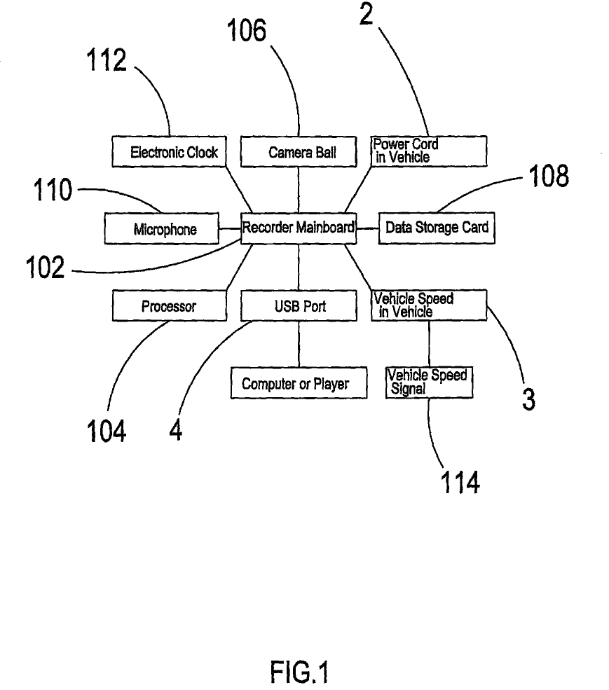

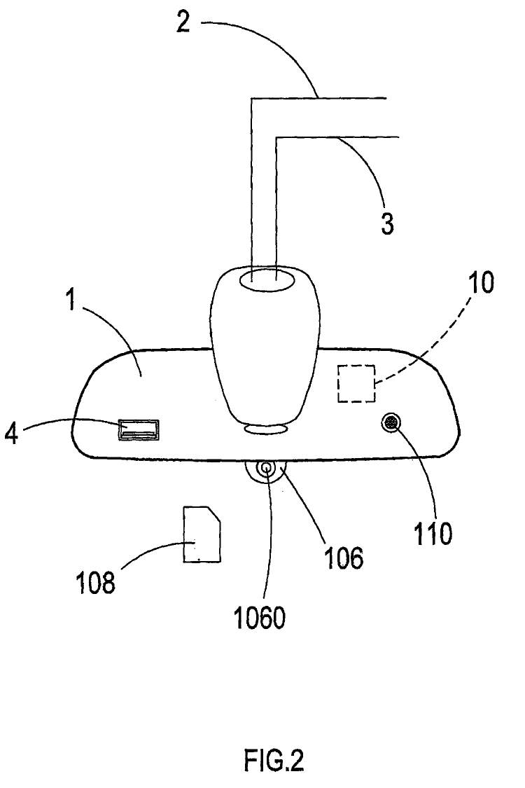

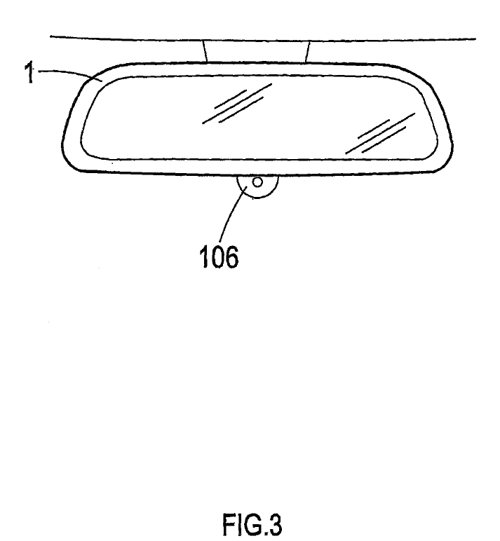

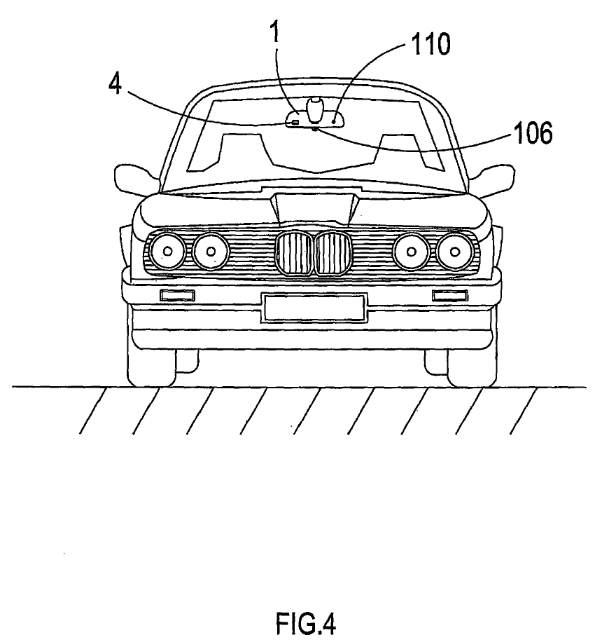

Referring to FIGS. 1 to 4, it shows a block diagram of an electronic video-audio recorder, a front view, a rear view and a schematic view of a state of use, of a preferred embodiment of the present invention. As shown in the drawings, the present invention is an on-board rear view mirror with an electronic video-audio recorder, wherein a mirror case 1 of an on-board rear view mirror includes an electronic video-audio recorder 10 which comprises a recorder mainboard 102 and a processor 104, a camera ball 106, a data storage card 108, a microphone 110, a time processing unit 112 and a vehicle speed signal wire 114 which are connected with the recorder mainboard 102 through connection wires. The camera ball 106 contains plural camera heads 1060 in plural directions, the electronic video-audio recorder 10 is assembled in the mirror case 1 of the on-board rear view mirror, and another three lead wires are connected respectively with an on-board power cord 2, a vehicle speed signal wire 3 and a USB port 4. Furthermore, except for the camera ball 106, all parts, connection wires and lead wires of the electronic video-audio recorder 10 are assembled and hidden in the mirror case 1 of the rear view mirror.

The processor 104 is an ordinary processor chip which integrates video and audio signals collected by the camera heads 1060 and the microphone 110, time of the time processing unit 112 and a vehicle speed information which are saved into the data storage card 108; whereas, the USB port 4 is used to connect a computer or a player.

In the present invention, four or plural built-in color micro video-audio camera heads 1060 are integrated in a housing which is in, but not limited to, a semi-circular shape, and are assembled as the camera ball 106 to be installed below the on-board rear view mirror. On the other hand, other parts are all integrated and installed normally in the on-board rear view mirror. The camera ball 106 is provided with a multi-directional shooting function and can look at conditions in front of, within, at a back side of, to a left of and to a right of, the vehicle.

The recording starts after energizing and the video and audio signals that are collected are integrated with the time and the vehicle speed through the processor 104, followed by being saved into a memory. A rolling method is used by the memory to record, in which data prior to a configured time is saved and deleted automatically. For example, if the configured time is 12 hours, then the memory will only store the data within the latest 12 hours and automatically delete the data 12 hours ago. An access capacity determines a time length of rolling recording.

By using the electronic video-audio recorder 10, images, sound, the vehicle speed at that time, a road condition nearby and any abrupt incident in a shooting range that happen at peripheries of the vehicle when the vehicle is moving can be recorded. With an accurate time, date and vehicle speed, these data can serve as evidences or be used for review, when necessary.

By the present invention, as long as that the vehicle is started or the power source is turned on, the pictures of roads can be recorded at any time. The present invention can be applied to plural or all vehicles; and in a future, the present invention can be listed as the standard equipment in new vehicles. In addition, a national institute or an individual can use the access equipment of the present invention to watch the video-audio pictures that are recorded. For a vehicle which is equipped with an on-board TV, the user can also watch the records or real-time pictures through an on-board video system at any time.

When a driver is driving on a road, he or she may often encounter some situations, such as that a bus is discharging black smoke, an overloaded truck is moving or is dumping wastes maliciously, a vehicle in front is running a red light or moving illegally; and these situations can all be recorded to report to a traffic control institute for rewarding. As a result, the drivers on the road can change from the illegal drivers to roles of upholding the traffic, and a traffic order can be greatly improved. On the other hand, there can be traffic accidents, criminal behaviors or even disasters on a road or sidewalk at any time. As there are always vehicles passing through on the road, we can find out the vehicles which pass through that area at that time, and it is possible to restore what happened or even capture images of many vehicles at different angles, thereby facilitating understanding a full story of the situation that happened at that time. Nowadays, in every country of the world, surveillance recording equipment are installed at major intersections in major cities, in order to better manage the traffic and security by using the recording function. If, by the present invention, the traffic recording can be popularized to a billion of vehicles in the world, then there will be a billion of mobile recording equipment to restore everything on the road.

Accordingly, as being assembled in the on-board rear view mirror, the present invention is covered well without being stolen and affecting the line of sight of the driver. As the present invention will be energized automatically to shoot automatically after the vehicle has started, there is no need to install the present invention repeatedly and the user will not miss out shooting by forgetting to turn on the present invention. In addition, as not being directly exposed by sunlight, the present invention can operate reliably to extend the lifetime of usage. As the present invention is assembled in the on-board rear view mirror, the camera heads will not swing and will not become the projectile to cause the accidental injury when two vehicles collide. Furthermore, the pictures in many different angles can be shot, the entire property of the present invention is good and the present invention can be installed easily.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An on-board rear view mirror with an electronic video-audio recorder, comprising a mirror case, wherein the mirror case includes an electronic video-audio recorder which is composed of a recorder mainboard and a processor, a camera ball, a data storage card, a microphone, a vehicle speed signal wire and a time processing unit displaying time and date in real time, that are connected with the recorder mainboard, with the recorder mainboard, the processor, the data storage card, the microphone and the time processing unit being assembled and hidden in the mirror case.

2. The on-board rear view mirror with an electronic video-audio recorder, according to claim 1, wherein the camera ball is provided with more than one camera head which faces toward a different direction, respectively.

3. The on-board rear view mirror with an electronic video-audio recorder, according to claim 1, wherein the camera ball is provided below the rear view mirror.

4. The on-board rear view mirror with an electronic video-audio recorder, according to claim 1, wherein the electronic video-audio recorder is provided with at least one lead wire which is connected with the vehicle speed signal wire.
